(19) United States
(12) Patent Application Publication
(10) Pub. No.: US 2019/0159477 A1
(43) Pub. Date: May 30, 2019

(54) DRY EXPANDED FOOD PRODUCT MADE FROM PROTEIN, AND METHOD FOR THE PRODUCTION THEREOF

(71) Applicant: PROTEIFOOD S.A., Enghien (BE)

(72) Inventors: Jean-Jacques Snappe, Festubert (FR); Pierre Olivier, Bruxelles (BE)

(21) Appl. No.: 16/320,965

(22) PCT Filed: Jul. 27, 2017
(86) PCT No.: PCT/EP2017/069067

§ 371 Date: Jan. 25, 2019

(30) Foreign Application Priority Data
Jul. 27, 2016 (BE) 2016/5616

(51) Int. Cl. A23J 3/26; A23L 33/105; A23L 33/19; A23L 33/00; A23C 19/086; A23C 19/09; A23P 30/32

(52) U.S. Cl. CPC A23J 3/26; A23V 2250/5424; A23L 33/19; A23L 33/40; A23C 19/086; A23C 19/0921; A23P 30/32; A23V 2002/00; A23V 2200/126; A23V 2200/3324; A23V 2200/228; A23V 2300/24; A23V 2250/5114; A23V 2250/5118; A23V 2250/548; A23L 33/105

(57) ABSTRACT

The invention relates to a dry expanded food product comprising the following essential ingredients: a food-grade protein concentrate of animal or plant origin, and residual water. The expansion can be obtained during a step of treatment in a microwave device.

### TECHNICAL FIELD

The present invention relates to a dry expanded food product made from protein for human or animal food and to a method for the production thereof. More specifically, the invention relates to a dry expanded food product of biscuit or flake or wafer type, in particular a nutritional crunchy product with low calories and good organoleptic properties, could be consumed such in a dry state or in a mixture with an edible liquid such as milk or water. In particular, the invention relates to a food product of biscuit or flake or wafer type, or long-preservation fermented milk product, without any cereal flour, but offering both the input of proteins (in particular for nutritional products) and the input of mineral salts, in particular calcium, magnesium, phosphorus and iron, necessary for children, adults, sportspeople and elderly people. The present invention also relates to an economic and effective method for producing such a dry expended food product.

### BACKGROUND OF THE INVENTION

Hyperproteinated biscuits, for example with a wheat flour, lupin flour, soya protein, wheat gluten base, and if necessary, acacia gum, baking powder, etc., are well known in dieting regimes for human food to make it possible to burn fat and lose weight, while preventing the loss of muscle mass. In this context, various biscuits, cakes, whey protein-based pancakes are also known. However, failing a method for effective and flexible large-scale production, such biscuits most often have a production cost and, consequently, a sale price which is too high for a broad share of the population. Moreover, it is also broadly recognised that, in this type of dry food product intended for human consumption and after physical or sports training, the crunchy character is often obtained at the expense of organoleptic properties.

Other proteinated products are designed to supplement pathological deficiencies, for example a protein deficiency linked to a high loss of muscle mass in certain cancers or associated with ageing. These products are presented in powder form to be dissolved in other foods, for example a milk product or a drink. They could highly benefit from a more attractive presentation and form the subject of a food, like a crunchy biscuit.

Despite the potential interest thereof for the dry biscuit sector, milk proteins, in the form of isolates or concentrates, also only have a low output for dietary products for human food, by comparison to the production of fresh cheeses, yogurts, drinks, ice creams, sauces, baby milks, and for animal food.

Moreover, dry expanded biscuits are already known for feeding pets such as dogs and cats, as well as horses.

U.S. Pat. No. 3,891,774 relates to production by extrusion, from a protein source such as animal flour, poultry flour, oil seed flour and preferably soya flour, a dry food product simulating meat and which can rehydrated, in this case, in a few seconds without heating. The protein source has a balanced water content of 4% to 12% by weight and a protein content of 30% to 75% by weight. The crucial factor of the method is the addition, at a level of between 10% and 50% by weight, of an organic solvent (glycerol, glycol propylene or a mixture of these), capable of laminating the protein source in the extruder. Overall, the method further comprises steps consisting of heating the mixture at a temperature greater than 100° C., applying increased pressures for a sufficient time while it emerges from said first restricted orifice, then extruding the material through a second restricted orifice in a pressure environment substantially less than said increased pressures to cause the expansion of the product with evaporation of at least some of the humidity and the formation of a dry expanded food product having a residual water content of 3% to 7% by weight when it comes out of the extruder. This document does not disclose the presence, nor the food-grade fat nor texturising additive.

The published American patent application no. 2005/089623 discloses a food product of density of between 0.02 and 0.5 g/cc comprising a protein which could be at least partially hydrolysed in a proportion of 25% to 95% by weight, and of water in a proportion of 1% to 7% by weight. The product can comprise a load, of which the majority can be starch, in a proportion of less than 50% by weight, and can comprise a fat-based surface coating. The preferred starch is rice flour, potato starch and tapioca, or the mixtures thereof. However, before extruding the product, it is preferred to maintain the fat proportion added to the mixture of solid components and water at a level less than 0.5% by weight.

Despite the preceding description of the prior art, there is also a need in the food technique for protein-based, dietary crunchy expanded products, in particular crunchy food products with very low starch and fat contents, offering a great variety of possible tastes, salty or sugary, according to the preferences of consumers. There is also a need in the food technique for protein-based crunchy expanded products of varied origins, animal and/or plant, making it possible to be adapted, both to the availability of local farming resources and to the dietary preferences of consumers, for example regarding vegetarian diets. There is also a need for crunchy products of the biscuit type for animal food, in particular for pets. There is also a need in the food technique for a method for producing such crunchy expanded products, which are economical and effective and which offers, at a low cost, a great flexibility according to the types of protein which can be used as starting materials, according to the organoleptic qualities of the desired products and according to the type of food, human or animal, aimed for.

### SUMMARY OF THE INVENTION

Surprisingly, it has been found that the needs expressed above in the human and animal food technique, as well as the dietary problems mentioned above could be advantageously resolved by means of new composition of improved material of dry expended food products and thermoexpandable food precursors as well as the production methods thereof.

### DETAILED DESCRIPTION OF THE INVENTION

A first aspect of the invention, described in application WO 2016/116426, therefore relates to a dry expanded food product comprising at least the following ingredients:
a food-grade protein concentrate of animal or plant origin,
a food-grade fat,
a food-grade texturising additive, selected from among the group constituted of hydrocolloids and plant gelling agents, starch preferably chemically-modified, proteolytic additives and the hydrolysed products thereof, acidifying agents and the salts thereof, and maltodextrins, and
residual water.

Such as expressed here, it must be understood that:
the food-grade fat constitutes a separate ingredient from, i.e. separately added to, the food-grade protein concentrate, and not a non-protein impurity of it;
the food-grade fat constitutes an ingredient mixed with the food-grade protein concentrate, and not a surface coating of it.

Optionally, the dry expanded food product according to the invention can comprise:
a food-grade salt derived from an organic or mineral acidifying agent, but preferably other than a citrate phosphate, and/or
a proteolytic additive, or the hydrolysed product thereof.

Preferably, the dry expanded food product according to the invention does not comprise ingredients, other than those listed above, contributing to the structural definition thereof. However, it can comprise taste-related auxiliary additives such as flavours, colourants and/or sweeteners.

By “protein concentrate of animal origin”, this means any origin other than human or plant. Thus, it could be a concentrate coming from insects.

By “dry product” in the sense of the present invention, this means a product of which the residual water content makes it possible to keep intact, the taste-related and organoleptic properties of origin for a duration of several months, preferably a duration of 2 to 30 months, without needing to store the product under usual food refrigeration conditions (temperature less than around 5° C.). This preservation property of the taste and organoleptic quality generally corresponds to a residual water content less than around 10% by weight, for example not exceeding around 9% by weight, or around 8% by weight, but most often at least around 3% by weight, for example at least 4%, at least 5%, at least 6% or at least 7% by weight. A person skilled in the art knows that it is not desirable, both from the viewpoint of the increasing production cost linked to removing the water, and from the viewpoint of preserving the product for an extended storage period, to decrease the residual water content in the food product below around 3% by weight. Conversely, a residual water content greater than 10% by weight no longer makes it possible, generally, to qualify the food product as a dry product. It goes without saying, whatever the type of packaging wherein it is packaged, and despite a residual water content thus selected, that the good preservation of the dry expanded product according to the invention over time cannot be ensured if the product is kept durably at a temperature greater than 25° C. It is always naturally advised, to store the dry expanded product, whatever the packaging used for the packaging thereof, in a fresh and dry place, i.e. in an air-conditioned space kept between around 10° C. and 20° C. on average, and at a controlled degree of hygrometry.

By “expanded product” in the sense of the present invention, this means an alveolate product, of which the air cells filled with air represent at least 50% of the volume of the product, if necessary at least 65% of the volume, or at least 80% of the volume, and even up to 85% of the volume. This expanded structure gives the product according to the invention a crunchy character which the consumer likes, which can be quantified, if needed, in particular by measuring the breaking force (expressed in N).

The dry expanded product of the first aspect of the invention is not a traditional industrial bakery product, mainly cereal flour-based (70% by weight of wheat flour in the case of crackers available on the market) and therefore containing large quantities of starch inherent to such a flour. The composition thereof comprises essential ingredients, all food-grade, such as specified above and in each of the appended claims. By “essential ingredients”, this means ingredients representing, together, at least around 96% of the weight of the product, preferably at least 98% of the weight of the product, and also more preferably, at least 99% of the weight of the product. These proportions extend relatively to the raw dry expanded product, i.e. before applying any coating or food topping to the surface thereof. The 100% by weight complement is constituted, if necessary, of optional ingredients such as sweeteners, colourants, and flavourings as detailed below.

By “food-grade”, this means, for each ingredient, a quality satisfying national and international standards in force regarding human or animal food safety, in particular relating to the purity of the ingredients and the non-contamination thereof by potentially dangerous physical, chemical or biological agents.

Like for traditional industrial biscuit products, the dry expanded product according to the invention can, for commercial needs linked to the appearance thereof and to the taste of the consumer, be covered, coated or topped by means of one or more layers of food-grade coating, well known in the art, of type and of quantity specific to not altering the main dietary, taste and organoleptic qualities thereof.

By “protein concentrate” which can be used for the dry expanded product and the production method according to the invention, this means a raw material, by and large, or mainly, constituted of proteins of a natural origin (animal or plant), and therefore exempt from non-nitrogenated main constituents usually encountered in cereal flours (around 70% by weight of starch in wheat flours) or animal flours. The “protein concentrate” present in the dry expanded food product according to the invention is therefore a preparation extracted from a raw material of a natural origin (animal or plant), and wherein the non-protein components have been removed in the main, by resorting to one or more of the well-known splitting, precipitation, extraction, separation, isolation, purification techniques, etc. According to the weight content in protein with respect to the dry material of the protein concentrate, and therefore according to the method for obtaining the protein concentrate, the term “protein concentrate” extends as also comprising “protein isolates” having a weight content in protein (with respect to the dry material) of at least 85% by weight. In measuring the commercial availability thereof, substantially anhydrous protein concentrates or protein isolates or concentrates with a controlled and reduced residual water content are preferred.

Numerous protein concentrates of a natural origin (animal or plant) suitable as ingredients for the dry expanded product and for the method according to the invention are available on the market. For protein concentrates of animal origin, milk protein concentrates can be cited, such as those extracted from cow's milk, goat's milk, mare's milk, buffalo's milk, ewe's milk, etc. The composition thereof is detailed below relating to a specific embodiment of the present invention.

The base composition of the dry expanded food product according to the first aspect of the invention described below comprises essential ingredients, of which a texturising additive which can be of added native starch (of botanic origin), preferably added modified starch, by itself or mixed with other texturising additives (such as defined below). Such as expressed here, it must be understood that starch constitutes an ingredient separate from, i.e. added separately to, the other essential ingredients (protein concentrate, fat), and not (case of native starch, in particular) an impurity of these. A person skilled in the art knows well starch modified by physical modification (for example, precooking on a cylinder, extrusion, or in an atomising tower), physico-chemical (for example, dextrinisation at a high temperature and at an extreme pH), biological (for example, hydrolysis controlled by an enzymatic system) or chemical (for example, reticulation or substitution) of native starch of botanic origin by a variety of well-known techniques, in order to modify, as desired, the chemical structure of either of the two constituting homopolymers thereof (amylose and amylopectin), and consequently one or more of the physical properties thereof such as the stability to heat or to shearing, viscosity, visco-stability, gelatinisation time, etc. All these modified starch forms are in the scope of the present invention. Non-limiting examples of food-grade modified starches are covered by the International Numbering system (INS) of food additives, and in particular are those modified by dextrin, an alkaline hydroxide, sodium hypochlorite, maltodextrins and cyclodextrins, one or more phosphates, acetic anhydride, propylene or ethylene oxide, succinates, monochloroacetic acid, and are commercially available. Selecting the type and the quality of modified starch will be dictated by the texturising effect desired for the final product. Preferably, added (preferably modified) starch represents less than 10% by weight, for example no more than 4.5% by weight, of the dry expanded food product (or no more than 3.5% by weight of the combined ingredients in the production method of the expandable precursor described below), in order to guarantee a dietary quality of the final expanded product which is distinguished from that of commercial products already known with a high starch content.

The base composition of the expanded food product according to the invention can, in particular, comprise at least one animal protein concentrate (for example milk or fish) or plant. As milk protein concentrates, those containing caseins, serum or soluble proteins, and/or extracts of these can be cited (for example, beta-lactoglobulin, alpha-lactalbumin, immunoglobulins, lactoferrin, etc.). For more details regarding the possible components of a milk protein concentrate, the article by J. J. Snappe et alia entitled “Protéines laitières” (“Milk proteins”) can be referred to, which appeared in Dossier Techniques de l'Ingénieur (Engineering Techniques Dossier) (June 2010).

As a protein concentrate of animal origin, also concentrates extracted from fishmeal can be cited, of which there are numerous commercial examples, or earthworms (Eisenia foetida).

As a protein concentrate of plant origin, plant protein concentrates such as proteins coming from leguminous plants (soya, peas, lupin, lentils, beans), from cereals (wheat, oat, maize, millet, barley, rye, buckwheat, rice, spelt, sesame), oil seeds (squash, flax, peanut, pumpkin) or oleaginous fruit (almonds, peanuts, pistachios, hazelnuts, walnuts), or extracts of these can be cited, but not in a limiting manner.

As a protein concentrate originating from insects, protein concentrates extracted from insect flours on the market such that, but without limitation to, grasshopper flours, weevil flours, caterpillar flours, silkworm flours, cricket flours (Locusta migrator and Gryllus bimaculatus).

Given the variety of protein concentrates which can be used for the method and the dry expanded food product according to the invention, it is easy to adapt the production at local availability while producing the whole range of desired dry expanded food products according to the characteristics of the local market.

The protein content of the animal protein concentrate (for example, milk or fish) or plant is very high, greater than 65% by weight, preferably greater than 75% by weight, preferably greater than 80% by weight, and even, in the case of protein isolates, greater than 85% by weight. The 100% by weight complement is usually constituted of water (preferably at most, around 5% by weight) and of inert impurities which could have a nutritional utility (for example, mineral salts such as calcium, carbohydrates, vitamins) in proportions not damaging the food quality nor the taste, dietary and/or organoleptic qualities of dry expanded food products according to the invention.

The physical form of the protein concentrate which can be used for the method and the dry expanded product according to the invention is not a particularly limiting characteristic of the present invention; however, a powder form with a controlled and regular grain size is clearly preferable, in particular for the miscibility with the other main ingredients. Ranges of grain sizes which are desired for the implementation of the invention depend on the protein source used and the commercial availability, but are generally of between around 30 and 200 m, preferably between 50 and 150 m, according to the origin, animal (for example, milk or fish) or plant, of the protein concentrate.

The base composition which can be used for the dry expanded food product and the method according to the first aspect of the invention further comprises, as an essential starting ingredient, food-grade fat. A fat capable of being emulsified without difficult is preferred with at least part, preferably the main part or all of it, of the animal protein concentrate (for example, milk or fish) or plant. As a fat, anhydrous milk fat, butter, liquid or powder cream, or food-grade plant fat or, subject to miscibility, the mixture thereof can therefore be used. According to a specific embodiment of the present invention, a fat making it possible, in a suitable quantity, to obtain an oil type emulsion in the water in the presence of the protein concentrate of animal or plant origin is preferred.

Conventionally, by anhydrous milk fat, this means the product obtained by separation from the cream or from the butter, then dehydration, without adding any additives. The anhydrous milk fat which can be used therefore usually has a maximum humidity of 0.1% by weight, a maximum content of 0.5% by weight in liposoluble compounds and a maximum oleic acidity of 0.3%. It can be produced from butter or cream after mechanical and/or thermal action, centrifugation and drying under vacuum. A specific fraction of anhydrous milk fat obtained, for example, by fractioned crystallisation can also be used.

As a food-grade plant fat, preferably a plant fat having a melting point at least equal to 25° C. can be used, such as for example a melting point of around 30° C. to 40° C. As non-limiting examples, margarines, hydrogenated or non-hydrogenated, copra, palm, colza, soya, sunflower or another common plant type can be cited.

The physical form of the fat used is not particularly limited, however characteristics ensuring a good miscibility, in the presence of water, with the animal or plant protein concentrate are advantageous from the viewpoint of the production of the dry expanded food product according to the invention, in particular from the viewpoint of the effectiveness to carry out the initial step of the production method thereof. For example, but in a non-limiting manner, in an embodiment with a milk protein concentrate, by choice a food-grade anhydrous milk fat or a food-grade plant fat can be used, or a mixture of both. It is also possible to use cheese, refined or not, in the form of cheese powder, in the full form thereof or only scraps coming from the cheese industry, as a fat source. Cheese indeed contains as one single ingredient, both fat and milk proteins.

The proportions of water, fat and animal protein concentrate (for example, milk or fish) or plant in the base composition (including the thermoexpandable precursor described below) for the dry expanded food product of the invention and the initial step of the method according to the invention can vary in broad limits on the condition of being capable of providing a substantially homogenous mixture, but can be easily determined by a person skilled in the art according to technical parameters, such as selecting the fat and the protein concentrate, the dietary and nutritional properties desired for the final food product, the expansion capacity and the crunchy character desired, and economical parameters such as the duration of the production process (in particular, the maturing step) and the cost price. These proportions are adjusted by a person skilled in the art so as to be able to easily produce, in the initial production step, the emulsion of the fat with some, preferably all, of the proteins, as well as the hydration of the animal protein concentrate (for example, milk or fish) or plant, while suitably adjusting the viscosity of the mixture in view of the following steps. To this end, it is generally preferable that the protein concentrate/water ratio by weight is between around 1/4 and 1/1, preferably between around 1/3 and 1/2. Likewise, the ratio by weight of the food-grade fat to water constitutes an important factor of the invention, and it is generally preferable that this fat/water ratio by weight is between around 1/5 and 1/3, preferably between 1/4 and 1/5, in the precursor before expansion/dehydration. This generally corresponds to a ratio by weight of the food-grade fat to water of 5/1 to 3/1 in the dry expanded product. In order to adhere to the aim of the dietary crunchy food product, the proportion of fat in the base composition which can be used for the dry expanded product and the initial step of the method according to the invention must be kept as reliable as possible. According to the fat selected (origin, melting point, hydrogenated character or not), and of the animal protein concentrate (for example, milk or fish) or plant selected, a person skilled in the art knows how to determine, empirically, and by means of a limited number of preliminary tests, the proportions of water, fat and protein concentrate which are the most suitable to carry out the initial step of the method according to the invention without difficulty while guaranteeing the dietary and nutritional condition of the final dry expanded product.

The composition which can be used for the dry expanded food product and the production method according to the invention comprises the addition, alternatively to the preferably modified starch described above, of at least one texturising agent or additive such as a hydrocolloid, a thickener, an emulsifier, a gelling agent, an acidifying agent or one of the salts thereof. Preferably, a hydrocolloid other than gelatine is selected. As non-limiting examples of texturisers which can be used, in particular agents of plant origin such as alginic acid can be cited; sodium alginates, potassium, ammonium, calcium and glycol propylene; carrageenans (kappa and iota); carob bean gum, oat, guar, acacia gum, tragacanth gum, xanthan gum, karaya gum, tara gum, gellan gum, gum ghatti, mannitol, and sodium carboxymethylcellulose, or the mixture of several of them. The added texturising agent type (for example, hydrocolloid) depends, in a manner known to a person skilled in the art, the increase of viscosity desired and of the type of texture desired for the final dry expanded food product. The proportion of added texturising agent (for example, hydrocolloid) is a sufficient quantity to obtain the texturising effect desired for the final expanded product, according to the type of texturising agent selected. It is usually between around 0.3% and around 10% by weight, preferably between 0.4% and 4% by weight of the dry expanded food product according to the invention.

The composition which can be used for the dry expanded food product according to the first aspect of the invention can comprise at least one proteolytic agent, or a hydrolysed product of it, intended to split at least some, preferably a major part or all, of the proteins present in the protein concentrate into smaller protein fragments, this splitting having the purpose of modifying the texture. A preferred proteolytic agent is therefore an enzyme of animal, plant or microbial origin of the category of proteases, in particular exo- and endopeptidases of which the splitting involves the use of a water molecule, or exopeptidases. Selecting this proteolytic agent, and the effective quantity thereof, depends, in a manner known to a person skilled in the art, on the proteins present in the protein concentrate used. According to a specific embodiment of the invention, when the food-grade protein concentrate is a milk protein concentrate, a suitable proteolytic additive is constituted of rennet or a natural protease (endopeptidase) extracted from the rennet, such as chymosin. Also, pure synthetic chymosin can be used obtained by fermenting a genetically-modified organism (for example, a mushroom such as Aspergillus niger). As other suitable proteolytic additives, on the one hand, pepsin, and on the other hand, active enzymes of plant origin such as cyprosine and cardosin can be cited. The effective quantity of proteolytic agent, or one of the hydrolysed products thereof, is usually very low, of around 20 to 200 ppm, and this agent is found therefore in the state of traces in the dry expanded food product according to the invention.

The composition which can be used for the dry expanded food product according to the first aspect of the invention can also comprise at least one acidifying agent salt, or a precursor of it, preferably other than a citrate or phosphate. The acidifying agent in question can be a strong or weak acid (such as defined by the pKa therefore in a manner well known to a person skilled in the art), mineral or organic. As a non-limiting example, sulphuric acid, gluconic acid, etc. can be cited. The acidifying agent salt or precursor must be of an acceptable quality for human or animal food. An acidifying agent salt which can be used, in particular when the food-grade protein concentrate is a soya protein concentrate, is calcium sulphate. An acidifying agent salt which can be used, in particular when the food-grade protein concentrate is a milk protein concentrate, is a gluconate or a food additive precursor such as delta-gluconolactone (additive E575). A lactic ferment or other living organism capable of acidifying the environment can also be used. A suitable quantity of acidifying agent salt, or a precursor of it, is a necessary and sufficient quantity to proceed with the acidification of the environment during the splitting of at least some, preferably a major part of all, of the proteins present in the protein concentrate into smaller protein fragments. Each additive can thus contribute to the coagulation of the mixture in the acid environment, for example by destabilising the proteins, in particular the caseins.

The composition of the dry expanded food product according to the invention can further comprise one or more auxiliary additives for production such as defined below, in order to give the product desirable nutritional properties (fibres) or taste-related properties (flavours, colourants, sweeteners).

A dry expanded product according to the invention, not comprising food-grade salt derived from an acidifying agent, and/or proteolytic additive or hydrolysed product of it, also has a very good expansion capacity, but a less pronounced crunchy character.

For the production of a dry expanded food product according to the invention, it is generally useful, but not necessarily, to have a thermoexpandable precursor capable of forming the product by simple heat expansion with reducing water content, for example by treatment by microwave means, or any other suitable treatment well known in the food industry. Such a thermoexpandable precursor therefore constitutes another aspect of the invention, and it comprises at least the following ingredients:
a food-grade protein concentrate of animal or plant origin,
a food-grade fat,
a food-grade texturising additive selected from among the group constituted of hydrocolloids and plant gelling agents, preferably modified starch, proteolytic additives and the hydrolysed products thereof, non-starch polysaccharides, acidifying agents and the salts thereof, and maltodextrins, on the condition that preferably modified starch represents less than 5% by weight of the precursor, and
water.

The thermoexpandable precursor according to the invention can further comprise a food-grade salt derived from an acidifying agent, preferably other than a citrate or phosphate, and/or a proteolytic additive or a hydrolysed product of it. Each of the ingredients of this precursor can be of a nature and in the quantity such as defined above to the subject of the dry expanded food product. Given that the thermal treatment of the thermoexpandable precursor will have the effect, simultaneously with the volume expansion, to reduce the water content up to the level of a residual content which is compatible with requirements for preserving for a long duration at an ambient temperature (around 15° C. to 25° C.), it goes without saying that the water content in the composition of the thermoexpandable precursor according to the invention exceeds 10% by weight. A suitable water content in the composition of the thermoexpandable precursor according to the invention depends on the number and on the respective proportions of the other essential ingredients and, if necessary, on the presence of optional ingredients such as food-grade salt derived from an acidifying agent, and/or the proteolytic additive or the hydrolysed product thereof. It also depends on the necessity to product a substantially homogenous mixture with other essential ingredients and viscosity conditions to produce an easy handling of the mixture according to the temperature conditions selected for the preparation method (see below). The series of examples provided below demonstrate that a suitable water content in the composition of the thermoexpandable precursor according to the invention is generally in the range from 50% to 85% by weight of all the ingredients taken together.

An illustrative but non-limiting method for preparing a thermoexpandable precursor comprises steps consisting of:
combining, at a temperature of between 4° C. and 60° C., the protein concentrate of animal or plant origin, the food-grade fat, the food-grade texturising additive and water, and
subjecting the mixture obtained to a thermal treatment in a temperature range of between 65° C. and 140° C.

If necessary, the preparation method can comprise at least one additional step consisting of adding a food-grade salt derived from an acidifying agent, preferably other than a citrate or phosphate, and/or a proteolytic additive or a hydrolysed product of it. A person skilled in the art knows how to determine, by simple routine tests, both the device type wherein the initial combination is produced (including the possible stirring means) and, if necessary, the suitable time for adding optional ingredients, according in particular to the thermal stability thereof and the reactivity thereof with the essential ingredients.

The invention also relates to a method for producing a dry expanded food product such as defined first and foremost, comprising steps of the method for preparing the thermoexpandable precursor, and further comprising the step consisting of subjecting the thermoexpandable precursor to heat, for example by microwave means, until causing the expansion therefore according to the desired expansion degree, and the reduction of water content until the desired residual content.

The method definitions above only comprise essential steps to achieve the aim of the invention. It goes without saying for a person skilled in the art, that optional intermediate steps, such as maturing, moulding, demoulding, crushing, grating, partial dehydration, can be added to facilitate the process resulting in the final expanded product in the desired form, in particular by providing it with a desirable texture. Below, a specific embodiment of a method for producing a dry expanded food product comprising such intermediate steps is described, in a non-limiting manner. This method comprises, only illustratively, at least the following steps:

(a) mixing, until homogenisation, a base composition comprising as essential ingredients, water, food-grade fat, at least one food-grade protein concentrate of animal or plant origin, and at least one food-grade texturising additive selected from among hydrocolloids and plant gelling agents and starch, and if necessary as optional ingredients, a food-grade salt derived from an acidifying agent, other than a citrate of phosphate, and/or a proteolytic additive or a hydrolysed product of it,

(b) subjecting the homogenous mixture obtained in step (a) to a thermal treatment by heating up to a temperature of between around 65° C. and 140° C., followed by a cooling down to a temperature not exceeding 50° C. as a maximum,

(c) if necessary, adding, during or after the cooling of step (b), at least one proteolytic additive or a hydrolysed product of it and at least one acidifying agent or a precursor or a salt of it, and homogenising the resulting mixture,

(d) pouring the homogenous mixture obtained in step (c) in a mould,

(e) if necessary, leaving the homogenous mixture to take the texture in the mould at a temperature of between 5° C. and 65° C. for a sufficient duration to proceed with the texturisation thereof,

(f) if necessary, crushing or grating, if necessary after a partial dehydration to lower the water content thereof down to a value of between 25% and 40% by weight, the coagulated mixture obtained in step (e) in order to adjust the grain size thereof in a predetermined range, and

(g) subjecting the mixture, if necessary, crushed or grated, and if necessary, partially dehydrated, obtained in step (e) or in step (f), to a microwave treatment to proceed with the expansion thereof and the dehydration thereof, until obtaining said dry expanded food product having the expansion ratio and the residual water content required.

Step (a) of the method according to the invention consists of homogenising the components of the base composition. This is carried out, preferably in a solid-liquid emulsifying mixer well known in the food industry, at a sufficient temperature and by providing a sufficient stirring, such that the homogenisation is reached in a minimum time. As a non-limiting example of devices which can be used for steps (a), (b) and (c) of the method according to the present invention, in particular dual-case mixer-cookers for heating and cooling, and direct steam injection such as universal UMSK machines commercialised by the Stephan department of the company Sympak Process Engineering GmbH (Schwarzenbek, Germany). Selecting the type of device (form of material flow deflector, rotor-stator type tool, etc.) and functioning parameters (direction of rotation and counter-rotation, stirring speed, etc.) of the solid-liquid mixer-emulsifier is in the scope of a person skilled in the art, by means of a limited number of preliminary tests, once the respective proportions of water, fat and animal or plant protein concentrate in the base composition are known. It is preferable that the stirring speed in the solid-liquid mixer is between around 500 and 2000 rpm, preferably between 800 and 1500 rpm. In case of using rotor/stator type devices, the speed equivalences will be given as shearing speeds, preferably between 5000 and 20000 s⁻¹, more preferably between 5000 and 10000 s⁻¹, for example around 7500 s⁻¹. Likewise, it is preferable that the content of the solid-liquid mixer is kept at a temperature of between around 4° C. and 60° C., preferably between around 45° C. and 60° C. The temperature can be controlled by means of a probe, and can be kept constant for the whole of step (a), or can be programmed according to a variable cycle if needed. According to the parameters (for example, the temperature and the stirring speed) selected for the functioning of the solid-liquid mixer, and the composition mass to be homogenised, the duration of step (a) is usually between around 5 and 30 minutes, preferably between around 10 and 20 minutes.

From step (a) of the method according to the invention, a homogenous mass (for example, paste or viscous liquid) is obtained wherein numerous air bubbles are likely to be closed. To continue the method according to the invention, it is preferable to proceed with the de-aeration of this mass. This is done by any suitable means, preferably by means of a putting under vacuum of the device containing the homogenous mass towards the end of step (a). Preferably, the putting under vacuum is avoided at the start of step (a) in order to avoid suctioning a part of the powder protein concentrate. Preferably, a vacuum of 0.1 to 0.9 bars is maintained. From this step, therefore a smooth, homogenous and de-aerated mass is obtained.

In a second step (b), the homogenous mixture is preferably de-aerated obtained in step (a) is subject to a thermal treatment. A preferred temperature range for the thermal treatment goes from around 65° C. to 140° C., preferably from around 65° C. to 90° C. Towards the end of step (b), the temperature of this homogenous mixture is left and if necessary de-aerated, to decreased up to around 60° C. as a maximum, for example 45° C. or even around 30° C., either naturally by thermal exchange with the surrounding environment, or by suitable active cooling means, such as refrigerant fluid circulation, ventilation, etc. Advantageously, step (b) can be achieved in the same device, of mixer-cooker type (for example, a device from the abovementioned manufacturer Stephan) as that in step (a), by using in a suitable manner, the heating and cooling means of it.

During the following step (c), other optional ingredients of the food product according to the invention can be added, namely at least one proteolytic additive or the hydrolysed product thereof and/or an acidifying agent salt or a precursor of it. The chemical nature and the added quantity of these two additives has already been detailed above. In this same step (c), a complement of at least one of the essential ingredients of the food product according to the invention can also be added, if necessary. Advantageously, step (c) can be achieved in the same device of mixer-cooker type (for example, a device from the abovementioned manufacturer Stephan) as step (a).

During step (a) and/or step (c), one or more auxiliary additives for production can also be added, useful for improving a set of desirable properties of the final dry expanded product. Among these properties, in particular the preservation duration, the flavour, the colour, the crunchy character, the fibre richness, etc. can be cited. The auxiliary additives for production, useful for this purpose entering into categories of additives well known to a person skilled in the art. These additives are normally added in very low proportions, generally less than 1% by weight for each of them, except for fibres for which the proportion can advantageous reach up to around 4% of the final product, according to the texture and the nutritional quality desired.

For example, one or more flavouring agents can be added, selected according to the taste to impart on the final dry expanded food product. For salty dietary biscuits, flavours, condiments or spices can be added in accordance with the use, for example paprika, pepper, clove, etc. For sugary dietary biscuits, natural or synthetic flavours can be added, such as vanilla, cinnamon, strawberry, raspberry, orange, pear, apple, etc. According to the nature thereof, and according to the intensity of the taste desired, the proportion by weight of the flavouring agent can be between 0.2% and 1% by weight.

At least one food-grade fibre, soluble or insoluble, can also be added. In order to not damage the production process, nor damage the other desired qualities of the final dry expanded product, soluble fibres are preferred. For example, these soluble food fibres are fructans, like inulin, fibre recommended in the food diet of diabetic people. Insoluble food fibres are, for example, cellulose or lignin.

At least one non-acidifying salt can also be added, such as a halide, for example a sodium chloride and/or iodide, which can fulfil, according to the added quantity, different functions: improvement of preservation, improvement of puffiness during the later step, modification of the taste, etc. The same proportions by weight as above are applied to adding non-acidifying salt. For dietary reasons, the proportion of salt must be as low as possible, except for if the dry expanded products are snack biscuits, known for the salty character thereof.

During step (c), one or more colourants can also be added, which are acceptable for human or animal food. Preferably, auxiliary additives for production are added in crushed form so as to be mixed easily with the de-aerated homogenous mass of the base composition.

During step (c), in the case where it is desired to obtain final products with a sugary flavour, one or more natural (such as saccharose or fructose) or synthetic (such as aspartame or acesulfame) sweeteners can also be added, in a sufficient quantity well known to a person skilled in the art to provide the sweetener level desired.

During step (d) of the method according to the present invention, if necessary, the mixture obtained from the mixture device (for example, a mixer-cooker such as described above) is poured into a mould, or any other solid support, of variable form and dimension wherein the maturing step (e) will take place.

Step (e) of the method according to the present invention, during which if necessary, acting on the homogenous mixture is left (texturisation or, as the case may be, coagulation and acidification), the optional constituents added in step (c), can be done for a short duration (for example, from 5 to 120 minutes) or relatively long for a few hours (for example, from around 2 to 24 hours), and at a temperature avoiding the denaturation of proteins or protein fragments present. This maximum temperature to not exceed, depends, in a manner known to a person skilled in the art, on the proteins (animal or plant) in question. For an effective production yield, and therefore to avoid an excessive maturing duration, optional step (c) is carried out at a minimum temperature of 5° C., preferably at least 15° C. Selecting the temperature of step (e) therefore results from a compromise between yield and necessity to avoid an unsuitable denaturation which lowers the nutritional quality of the final food product.

Then follows optional step (f) of the method according to the present invention, during which an adjustment is proceeded with, preferably with a reduction, of an average solid particle size resulting from the texturisation/dehydration and, if necessary, with a partial dehydration of the additive-filled homogenous mass. In this step, the water content of the additive-filled homogenous mass can be significantly reduced until a content of between around 25% and 40% by weight, preferably between 28% and 35% by weight. The partial dehydration at this stage is optional, given that it can also be carried out completely in the final step, subject to having a suitable device for microwave treatment. On the other hand, the average solid particle size is decreased by any suitable mechanical means, such as crushing or grating, until an average size of between around 50 μm and 2 mm, preferably between around 100 μm and 1 mm. The form of the particles obtained from step (f) does not constitute a critical parameter of the present invention. The term “particle” does not imply a specific geometric form. In the context of the method according to the present invention, any form, spherical or not, extended or not (for example, strands), can suit, on the condition of being able to be expanded by a sufficient coefficient in the later step (g). According to a specific embodiment of the present invention, the size reduction type brought about also aims to reduce the dispersity of particle sizes, i.e. to obtain a particle population of sizes as homogenous as possible. This step (f) can be important in that the performance of the material in the later step of microwave treatment has been found broadly dependent of the parameters such that the residual water content, the average solid particle size, and the dispersion of the sizes thereof.

Finally, the final step leading to the obtaining of the dry expanded food product (of biscuit or flake type) consists of subjecting the paste, dehydrated or not, crushed or not, obtained in step (f) to a thermal treatment such as by microwave. This treatment generally has the effect of also lowering the water content in the final product, down to a value which can be between around 3% and 10% by weight, which is compatible with long-duration preservation requirements, while proceeding with the expansion of the paste according to an expansion ratio (by volume) of around 1.5 to 6.0, for example around 2.0 to 3.5. The parameters of this microwave treatment, such as duration, power, wavelength, etc., can be easily adjusted by a person skilled in the art according to the water content, the average size and the dispersion of proteinated material particle sizes, as well as the form and the volume of the finished products, etc.

In a non-limiting manner, the following parameters can be cited:
a varying wave frequency in the usual range of microwave devices on the market,
a varying power in a range of between around 200 W and 1000 W,
a varying duration in a range of between around 10 and 120 seconds, preferably between around 20 and 100 seconds.

A dry and crunchy food product is obtained from this step, ready to be conveyed by conveyor belt to a loose or single sub-assembly packaging system. If necessary, from step (g), a statistical quality control system can be provided, for example a system comprising the measuring of the crunchy character such as, for example, the measuring of the breaking force (in N), in order to remove the products which do not meet the standard set.

The following examples are provided for purely information and illustrative purposes of the present invention and must not be interpreted as limiting the scope. These examples can be modified by adjusting one or more operational parameters (temperature, duration, dimensions) inside quantified ranges mentioned in either of the preceding paragraphs.

### EXAMPLE 1

For this example, the material used is a Thermomix of the brand Vorwerk, for a volume of 1.5 L. To produce the base, 27.71 g of standard anhydrous milk fat (AMF) (supplier: Corman S.A., Belgium) are melted in 198 ml of source water by heating at 50° C. and while gently stirring (Thermomix in position 1) for 5 minutes. Then, a powder-type mixture, containing 75.02 g of Promilk SH20 proteins (supplier: Ingrédia, Arras, France) and 10.52 g of a chemically-modified starch (commercialised under the brand CH20/20 CLEARAM® by the company Roquette Frères, France) and added while gently stirring (position 1 of the Thermomix). The mixture is maintained at 50° C. for 10 minutes, but the stirring is increased (position 3). The Thermomix is then adjusted to 90° C. and, once this temperature is reached, it is maintained for 30 seconds (Thermomix in position 1). The mixture is then directly moulded and placed in a refrigerated chamber at 4° C. After 4 hours of gelation, the product is demoulded then split into cylindrical discs of 18 mm in diameter and 12 mm in height which are directly inserted into an Ultra FD 1000 dehydrator of the brand Ezi Dri (of the company BestBay Pty Ltd, Australia), of which the temperature setpoint is adjusted to 30° C., in order to adjust the humidity thereof to 20% (drying time of around 18 hours). The dried discs are put into a microwave oven with a power of 750 W for 45 seconds. The volume obtained after passage to the microwave oven is, on average, 200% with respect to the initial volume [(volume after cooking)/(volume before cooking)*100%]. The product obtained is crisp and crunchy and has a relatively neutral taste. The form obtained after drying and similar to that after cooking.

### EXAMPLE 2

The method of example 1 is repeated, except for the modified starch-type texturiser being replaced by an iota-carrageenan to give to the base, the properties of a firm and elastic gel. For this recipe, the initial mixture contains 17.89 g of standard anhydrous milk fat (supplier: Corman) and 131 ml of source water. Then, a mixture of 50.23 g of PROMILK SH20 proteins (supplier: Ingrédia) and 2.10 g of iota-carrageenans (brand: Textura, supplier: Albert y Ferran Adria, Barcelona, Spain) are added to it. The remainder of the method is identical to example 1, but the main difference resides in the obtaining of a firmer gel and therefore a gel which is more easily transformable into discs with the desired dimensions. The average final expansion is also further increased and is equal to 250% [(volume after cooking)/(volume before cooking)*100%]. The product obtained is characterised by a preserved form, a thin air cell structure, and a crisp texture.

### EXAMPLE 3

The method of example 1 is repeated, but the milk proteins are replaced by soya proteins in the form of DENA SOYA PROTEINS 90 C LES protein isolate (supplier: Solina Group). The texturiser used is precipitated calcium sulphate (purity of 99.9%). For this mixture, 27.30 g of standard anhydrous milk fat (supplier: Corman, Belgium) are melted in 450 ml of source water. Then, a mixture of 75.45 g of soya proteins and 1.0 g of calcium sulphate is added while stirring, following the same method as for example 1. For this test, the temperature of 90° C. is maintained for 15 minutes to obtain a gel by thermal coagulation. The base obtained is easily split and does not spread thanks to the firmness thereof. The puffiness resulting from the microwave treatment is greater than 300% [(volume after cooking)/(volume before cooking)*100%]. The product obtained is of a darker colour (due to the soya proteins), with lots of air cells and crisp upon tasting.

### EXAMPLE 4

In a mixer-cooker-emulsifier, with a dual case for heating and cooling, and with direct steam injection, and of volume 24 litres commercialised by the Stephan department of the company Sympak Process Engineering GmbH (Schwarzenbak, Germany), the following are introduced: 1950 g of anhydrous milk fat, 8475 g of water, 2550 g of milk protein isolate (86% protein content by weight with respect to the dry material) commercialised by the company Ingrédia (Arras, France) under the reference Promilk SH20, 1500g of camembert powder (reference 10034 of Dairygold Food Ingredients Ltd., Ireland), 225 g of food-grade modified maize starch (reference CH20, supplier: Roquete Freres, France) and 75 g of Gouda flavouring (reference RD60A25204 of Dairygold Food Ingredients Ltd., Ireland). This mixture is homogenised and emulsified (emulsion of oily globules suspended in water, and colloidal casein suspension in the aqueous phase) at the temperature of 50° C. for a duration of 10 minutes. For the whole duration of the homogenisation process, the device is put under vacuum (0.5 bars) in order to substantially de-aerate the homogenous mixture obtained. The de-aerated homogenous mixture is then subjected, in the same device, to a thermal treatment at the temperature of 80° C. for a duration of 30 seconds, then is cooled down to the temperature of 45° C. At this temperature, and still in the same device, 225 g of food additive E575 (delta-gluconolactone commercialised by the company Acros) is then added, and 1.65 ml of chymosin produced by fermentation, commercialised by Chr. Hansen (Arpajon, France) under the name Chy-Max. After mixing at 600 rpm, the mixture (representing a total weight of 15.0 kg) is subtracted from the Stephan mixer and poured into rectangular moulds, each of volume 1 litre. The coagulation-acidification is left to be produced in the moulds for 24 hours at the temperature of 20° C. The pH measured at the end of this step of 5.5. From this time, the content of each mould is cut into thin slices then subjected to a pre-drying in a heat chamber ventilated at 35° C. for 10 hours until reaching a water content of 30% by weight in the pre-dried, coagulated mixture. The product is cooled to 10° C. so as to increase the firmness thereof and then the grating of the pre-dried mixture into thin strands is proceeded with (longitudinal dimension 10 to 20 mm, transverse dimension 1 to 2 mm) by means of a Handmark machine before subjecting the pre-dried, grated mixture to an atmospherically pressurised expansion treatment in a microwave oven (power 750 W, duration 90 seconds, at the frequency of 2.45 GHz), in silicone moulds. After demoulding, then 7.13 kg of a crunchy, dry expanded food product is obtained, of Gouda-tasting cheese type, of which the residual water content measured is 5.0% by weight. The composition by weight of this product is therefore around the following: 59% of milk proteins, 28.4% of milk fat, 3.27% of food-grade starch, 3.27% of gluconate, rennet traces, 1.09% of flavouring agent, and 5.0% of water.

For the preservation of the tasting and organoleptic properties thereof, it is recommended to package and store this product in a dry zone with a controlled hygrometry.

From a nutritional viewpoint, 100 g of the product corresponding to an energy input of 565 kcal.

### EXAMPLE 5

The method of example 4 is repeated, but in a mixer-cooker-emulsifier of volume 5 litres and from the following quantities of ingredients: 1102 g of water, 135 g of anhydrous milk fat, 225 g of milk protein isolate (protein content 85.5% by weight with respect to the dry material) commercialised by the company Ingrédia (Arras, France) under the name Promilk 852A, 15 g of food additive E575 (delta-gluconolactone commercialised by the company Acros), 0.16 ml of chymosin produced by fermentation, commercialised by Chr. Hansen (Arpajon, France) under the name Chy-Max, and 23 g of a powdered plant hydrocolloid texturiser (instead of starch of example 1) commercialised under the name Sosa and comprising alginate, carrageenan, and carob bean gum and xanthan. After adding chymosin and E575, the product is stored in a refrigerated chamber at 5° C. for 4 hours until obtaining a pH of around 5.0. The block obtained is thus portioned in cylinders of 18 mm in diameter and 12 mm in height, which are pre-dried until reaching a humidity rate of around 18% by weight, then subjected to a microwave treatment (power 850 W) for 30 seconds, atmospherically pressurised. After demoulding, thus 427 g of a crunchy dry expanded food product of cheese type of which the residual water content measured is 6.9% by weight. The composition by weight of this product is therefore around the following: 52.6% of milk proteins, 31.9% of milk fat, 3.27% of food-grade hydrocolloid texturiser, 3.5% of gluconate, rennet traces, and 6.9% of water.

### EXAMPLE 6

The method of example 4 is repeated, by decreasing the quantity of chymosin to 0.36 ml, but by preserving the quantities of the other ingredients. The slicing capacity of the product before pre-drying and grating is not affected, and the expansion, crunchy and taste characteristics of the final product are identical to those of example 1.

### EXAMPLE 7

The method of example 4 is repeated, but by replacing the milk protein Promilk SH20 with an identical quantity of the milk protein Promilk 852A (that used in example 2). The slicing capacity of the product before pre-drying and grating is not affected. The expansion and taste characteristics of the final product are identical to those of example 1, but the crunchy character is slightly less.

### EXAMPLE 8

The method of example 4 is repeated, but by replacing 2550 g of milk protein isolate Promilk SH20 with a mixture of 2295 g of Promilk SH20 and of 255 g of insoluble fibres commercialised by the company Cosucra (Pecq, Belgium) under the name Fibruline. The slicing capacity of the product before pre-drying and grating is not affected, and the expansion, crunchy and taste characteristics of the final product are identical to those of example 1, but because of the content thereof of around 3.5% in fibres, the expanded product obtained benefits the “fibre source” nutritional claim.

### EXAMPLE 9

The method of example 4 is repeated, but by replacing 225 g of modified maize starch with 60 g of alginate commercialised by the company Cargill (Minneapolis, United States) under the reference S550, or with 60 g of carrageenan commercialised under the reference Carragel MCH 5311 by the company Gelymar (Santiago, Chile), or with 22.5 g of carob bean gum Viscogum Be commercialised by the company Cargill (Minneapolis, United States), or with 22.5 g of xanthan gum XGT FN commercialised by the company Jungbunzlauer (Pernhofen, Austria). The expansion, crunchy and taste characteristics of the final product are substantially identical to those of example 1. This demonstrates that starch can advantageously be replaced, in whole or in part, by other hydrocolloidal texturising agents.

A second aspect of the invention relates to a food-grade dry expanded product comprising the following ingredients:
a food-grade protein concentrate of animal or plant origin,
a food-grade texturising additive selected from among the group constituted of hydrocolloids and plant gelling agents, preferably chemically-modified starch, proteolytic additives and the hydrolysed products thereof, non-starch polysaccharides, acidifying agents and the salts thereof, and maltodextrins, and
residual water.

In literature, expanded food products constituted by ternary mixtures of carbohydrates, lipids and proteins are known. The water content thereof can be from 10% to 35% before expansion, and up to 10% after expansion. The expansion can be obtained by extrusion or by rapid heating by microwave of a gelatinised article, and can reach a coefficient of 3 to 5.

The production of a dry and expanded cheese product is also known, consisting of subjecting a material of cheese origin having a water content of 25% to 65% by weight to a drying/expansion treatment by passage into a microwave oven under vacuum at a temperature of 400° C. until a water content less than 10% by weight, for 20 seconds to 10 minutes, making it possible to reach an expansion coefficient of 2.5 to 4.0.

A crunchy product is also known, protein-rich and low-fat, obtained from a mixture of 18% to 38% by weight of whey, soya, rice or pea proteins, of 5% to 30% of starch and of 40% to 65% by weight of water, with the addition of a preserving agent, obtained by expanding the mixture by heating in a microwave oven. An expanded cheese product is also known by heating by microwave, comprising 20% to 59% by weight of a milk protein, 10% to 50% by weight of starch, 2% to 24% by weight of a sugar alcohol (sorbitol, xylitol, mannitol or glycerol), and 3% to 15% by weight of water, wherein the fat content does not exceed 10% by weight. These products however lack nutritional character, because of the proportion of added starch and sugar.

The preparation of granular milk products and expanded by microwave treatment of a powder-form hard cheese having particles of a size of 0.2 mm to 5 mm and a humidity content not exceeding 45% until obtaining a humidity content of less than 15% is also known. The product obtained is however limited by the taste qualities and the starting cheese fat content.

A thermoexpandable precursor is also known for forming a synthetic cheese, comprising (by weight) 12% to 26% of milk protein, 7% to 30% of starch and 46% to 60% of water, said precursor comprising no more than 10% fat. After thermal expansion, this precursor forms a crunch synthetic cheese, comprising (by weight) 20% to 59% of milk protein, 12% to 68% of starch and 3% to 15% of water, said synthetic cheese comprising no more than 22% fat.

### EXAMPLE 1

For this example, the material used is a Thermomix of the brand Vorwerk of a volume of 1.5 L. To produce the base, 17.89 g of standard anhydrous milk fat (supplier: Corman S.A., Belgium) are melted in 131 ml of source water by heating to 50° C. and while gently stirring (Thermomix in position 1) for 5 minutes. Then, a powder-type mixture, containing 50.23 g of Promilk SH20 proteins (supplier: Ingrédia, Arras, France) and 2.10 g of iota-carrageenan powder (brand: Textura, supplier: Albert y Ferran Adria, Barcelona, Spain) is added while gently stirring (position 1 of the Thermomix). The mixture is maintained at 50° C. for 10 minutes but the stirring is increased (position 3). The Thermomix is then adjusted to 90° C. and, once this temperature is reached, it is maintained for 30 seconds (Thermomix in position 1). The mixture is then directly moulded and placed in a refrigerated chamber at 4° C. After 4 hours of gelation, the product is demoulded then split into cylindrical discs of 18 mm in diameter and 12 mm in height which are directly inserted in an Ultra FD 1000 dehydration device of the brand Ezi Dri (of the company BestBay Pty Ltd, Australia) of which the temperature setpoint is adjusted to 30° C., in order to adjust the humidity thereof to 20% (drying time of around 18 hours). The main characteristic advantageously obtained resides in the obtaining of a very firm and elastic gel and therefore easily transformable into discs with the desired dimensions. The dried discs are put into a microwave oven with a power of 750 W for 45 seconds. The volume obtained after passage to the microwave oven is, on average, 250% with respect to the initial volume [(volume after cooking)/(volume before cooking)*100%]. The product obtained is characterised by a preserved form (the form obtained after drying is similar to that after cooking), a thin air cell structure, a crisp and crunchy texture, and a relatively neutral taste.

### EXAMPLE 2

The method of example 1 is repeated, but the milk proteins are replaced by the soya proteins in the form of protein isolate DENA SOYA PROTEINS 90 C LES (supplier: Solina Group). The texturiser used is precipitated calcium sulphate (purity of 99.9%). For this mixture, 27.30 g of standard anhydrous milk fat (supplier: Corman, Belgium) are melted in 450 ml of source water. Then, a mixture of 75.45 g of soya proteins and of 1 g of calcium sulphate is added while gently stirring, following the same method as for example 1. For this test, the temperature of 90° C. is maintained for 15 minutes to obtain a gel by thermal coagulation. The base obtained is easily split and does not spread thanks to the firmness thereof. The puffiness resulting from the microwave treatment is greater than 300% [(volume after cooking)/(volume before cooking)*100%]. The product obtained is of a darker colour (due to the soya proteins), with lots of air cells and crisp to the taste.

### EXAMPLE 3

In a mixer-cooker-emulsifier, with a dual case, for heating and cooling, and with direct steam injection, and of volume 24 litres commercialised by the Stephan department of the company Sympak Process Engineering GmbH (Schwarzenbek, Germany), 1950 g of anhydrous milk fat, 8475 g of water, 2550 g of milk protein isolate (86% protein content by weight with respect to the dry material) commercialised by the company Ingrédia (Arras, France) under the reference Promilk SH20, 1500 g of camembert powder (reference 10034 of Dairygold Food Ingredients Ltd., Ireland), and 75 g of Gouda flavouring (reference RD60A25204 of Dairygold Food Ingredients Ltd., Ireland) are introduced. This mixture is homogenised and emulsified (emulsion of oily globules suspended in water, and colloidal casein suspension in the aqueous phase) at the temperature of 50° C. for a duration of 10 minutes. For the whole duration of the homogenisation process, the device is put under vacuum (0.5 bars) in order to substantially de-aerate the homogenous mixture obtained. The de-aerated homogenous mixture is then subjected, in the same device, to a thermal treatment at the temperature of 80° C. for a duration of 30 seconds, then is cooled to the temperature of 45° C. At this temperature, and still in the same device, then 225 g of food additive E575 (delta-gluconolactone commercialised by the company Acros), and 1.65 ml of chymosin produced by fermentation, commercialised by Chr. Hansen (Arpajon, France) under the name Chy-Max are added. After mixture at 600 rpm, the mixture (representing a total weight of 14.8 kg) is removed from the Stephan mixer and poured into rectangular moulds, each of a volume of 1 litre. The coagulation-acidification is left to be produced in the moulds for 24 hours at the temperature of 20° C. The pH measured at the end of this step is 5.5. From this time, the content of each mould is cut into thin slices, then subjected to a pre-drying in a ventilated heat chamber at 35° C. for 10 hours until reaching a water content of 30% by weight in the coagulated, pre-dried mixture. The product is cooled to 10° C. so as to increase the firmness thereof and the grating of the pre-dried mixture into thin strands is proceeded with (longitudinal dimension of 10 mm to 20 mm, transverse dimension of 1 mm to 2 mm) by means of a Handmark machine before subjecting the pre-dried, grated mixture to an atmospherically pressurised expansion treatment in a microwave oven (power 750 W, duration 90 seconds, at the frequency of 2.45 GHz), in silicone moulds. After demoulding, then 7.13 kg of a crunchy dry expanded food product of cheese type with a Gouda taste, of which the residual water content measured is 5.0% by weight is obtained. The composition by weight of this product is therefore around the following: 61% of milk proteins, 29.3% of milk fat, 3.38% of gluconate, rennet traces, 1.13% of flavouring agent, and 5.17% of water.

For the preservation of the tasting and organoleptic properties thereof, it is recommended to package and store this product in a dry zone with controlled hygrometry.

From a nutritional viewpoint, 100 g of the product corresponding to an energy input of 565 kcal.

### EXAMPLE 4

The method of example 3 is repeated, but in a mixer-cooker-emulsifier of a volume of 5 litres and from the following quantities of ingredients: 1102 g of water, 135 g of anhydrous milk fat, 225 g of milk protein isolate (85.5% protein content by weight with respect to the dry material) commercialised by the company Ingrédia (Arras, France) under the name Promilk 852A, 15 g of food additive E575 (delta-gluconolactone commercialised by the company Acros), 0.16 ml of chymosin produced by fermentation, commercialised by Chr. Hansen (Arpajon, France) under the name Chy-Max, and 23 g of a powdered plant hydrocolloid texturising agent commercialised under the name Sosa and comprising alginate, carrageenan, and carob bean and xanthan gums. After adding chymosin and E575, the product is stored in a refrigerated chamber at 5° C. for 4 hours until obtaining a pH of around 5.0. The block obtained is thus partitioned into cylinders of 18 mm in diameter and 12 mm in height, which are pre-dried until reaching a humidity rate of around 18% by weight, then subjected to a microwave treatment (power 850 W) for 30 seconds, atmospherically pressurised. After demoulding, then 427 g of a crunchy dry expanded food product of cheese type is obtained, of which the residual water content measured is 6.9% by weight. The composition by weight of this product is therefore around the following: 52.6% of milk proteins, 31.9% of milk fat, 3.27% of food-grade hydrocolloid texturiser, 3.5% of gluconate, rennet traces, and 6.9% of water.

### EXAMPLE 5

The method of example 3 is repeated, by decreasing the quantity of chymosin down to 0.36 ml, but by preserving the quantities of the other ingredients. The slicing capacity of the product before pre-drying and grating is not affected, and the expansion, crunchy and taste characteristics of the final product are identical to those of example 1.

### EXAMPLE 6

The method of example 3 is repeated, but by replacing the milk protein Promilk SH20 with an identical quantity of the milk protein Promilk 852A (supplier: Ingrédia, Arras, France). The slicing capacity of the product before pre-drying and grating is not affected. The expansion and taste characteristics of the final product are identical to those of example 1, but the crunchy character thereof is slightly less.

### EXAMPLE 7

The method of example 3 is repeated, but by replacing 2550 g of the milk protein isolate Promilk SH20 with a mixture of 2295 g of Promilk SH20 and of 255 g of insoluble fibres commercialised by the company Cosucra (Pecq, Belgium) under the name Fibruline. The slicing capacity of the product before pre-drying and grating is not affected, and the expansion, crunchy and taste characteristics of the final product are identical to those of example 1, but because of the content thereof of around 3.5% in fibres, the expanded product obtained benefits from the “fibre source” nutritional claim.

### EXAMPLE 8

The method of example 3 is repeated, but by adding 60 g of alginate commercialised by the company Cargill (Minneapolis, United States) under the reference S550, or 60 g of carrageenan commercialised under the reference Carragel MCH 5311 by the company Gelymar (Santiago, Chile), or 22.5 g of carob bean gum Viscogum Be commercialised by the company Cargill (Minneapolis, United States), or 22.5 g of xanthan gum XGT FN commercialised by the company Jungbunzlauer (Pernhofen, Austria). The expansion, crunchy and taste characteristics of the final product are substantially identical to those of example 1. This demonstrates the advantageous role of the whole range of hydrocolloid texturising agents.

### EXAMPLE 9

In a mixer-cooker-emulsifier with a mixer cutter of a volume of 5 litres, with a dual case for heating and cooling, commercialised by the Stephan department of the company Sympak Process Engineering GmbH (Schwarzenbek, Germany), 1140 ml of source water is introduced, which is brought to 70° C. while gently stirring. Then, a powder-type mixture, containing 300 g of milk protein isolate (86% protein content by weight with respect to the dry material) commercialised by the company Ingrédia (Arras, France) under the reference Promilk SH20 (identical to that used in example 3) and 22.5 g of a powdered plant hydrocolloidal texturising agent commercialised under the name Sosa and comprising carrageenan and carob bean gum (the same as that used in example 4) is incorporated while gently stirring (300 rpm). The mixture is maintained at 70° C., for 20 minutes with the same stirring. It is then cooled, still while stirring down to 45° C. to incorporate 15 g of the food additive E575 (delta-gluconolactone commercialised by the company Acros) to it, then after 30 seconds, 0.20 ml of chymosin produced by fermentation, commercialised by Chr. Hansen (Arpajon, France) under the name Chy-Max.

The mixture is then transferred directly into a container and preserved at ambient temperature (around 20° C.) for 4 hours, then placed in a chamber refrigerated to 4° C. After 24 hours, the produced is demoulded then split into cubes of 14 mm which are directly inserted into an Ultra FD 1000 dehydration device of the brand Ezi Dri (of the company BestBay Pty Ltd, Australia) of which the temperature setpoint is adjusted to 30° C., in order to adjust the humidity thereof to 16% (drying time of around 18 hours). The dried discs are put into a refrigerator at 4° C. for 24 hours. The discs are then put into a microwave oven with a power of 1800 W for 28 seconds. The volume obtained after passage to the microwave oven is, on average, 280% with respect to the initial volume [(volume after cooking)/(volume before cooking)*100%]. The product obtained is crisp and crunchy and has a neutral taste with a measured water content of 10.2% by weight.

A third aspect of the invention relates to a dry expanded food product comprising at least the following structural ingredients:
a food-grade protein concentrate of animal or plant origin, and
water.

As illustrated in the following examples 1 and 2, it has been demonstrated that it is possible to prepare a dry expanded food product only comprising, as structural ingredients, ingredients of the group constituted of a food-grade protein concentrate of animal or plant origin, and residual water.

Patent application WO2016/116426 relates to a dry expanded food product comprising, as structural ingredients: a food-grade protein concentrate of animal or plant origin, a food-grade fat, a food-grade texturising additive, and residual water. The product of the present application is already distinguished from this application by the absence of texturising additive and of fat.

When it is specified that a dry expanded product is constituted of certain structural ingredients, it must be understood that it can furthermore contain other non-structural ingredients, and in particular aromatic auxiliary additives, nutritional and/or aesthetic. The limitation here is only based on the structural ingredients.

The structural ingredients are those contributing, through the nature thereof, to the structure of the product, i.e. to the expansion capacity thereof and the crisp and crunchy texture thereof. Fat, water, texturising additives, proteins, starch, flour and yeasts are examples of structural ingredients. The structural ingredients represent at least 50% by weight of the final product and preferably at least 80% by weight of the final product, and also more preferably at least 90% by weight of the final product.

In certain cases, it is useful to add, as a structural ingredient, food-grade fat, as defined above. This can make it possible to obtain structural variants of the dry expanded product of the invention. The dry expanded product can only comprise as a structural ingredient, a food-grade protein concentrate of animal or plant origin, food-grade fat and water.

The invention also relates to a method for producing a dry expanded food product constituted of or comprising a food-grade protein concentrate of animal or plant origin, and residual water, production method wherein
a thermoexpandable precursor constituted of or comprising the following ingredients:
a food-grade protein concentrate of animal or plant origin, and
water,

preparation method comprising the step consisting of:
combining, at a temperature of between 4° C. and 100° C., the protein concentrate of animal or plant origin and water, and
the thermoexpandable precursor is subjected to heat, in a microwave-type device, to cause the expansion thereof and the reduction of water content down to a residual content.

As specified above, it is also understood here that the thermoexpandable precursor is the mixture of ingredients obtained before the expansion step, a step generally consisting of a heating with microwaves and during which the water content is reduced to the residual content.

The microwave heating can initially be done at all available microwave powers in domestic, professional or industrial devices. According to the power, the cooking time must be adapted. Preferably, the power range which can be used in a domestic or professional microwave oven is from 200 W to 2000 W. The frequency generally used is 2.45 GHz.

In an industrialisation angle of the method, the microwave device used can be a “microwave tunnel”, i.e. a microwave oven through which a belt can circulate on which are deposited thermoexpandable precursors to be subjected to heat. An example is an oven of the brand AMTek, with a power of 75 kW having an oven assembly of MWO2448-75 and a transmitter assembly of reference AMT7510, functioning at a frequency of 915 MHz. The speed of the belt is adjusted such that the passage time of the thermoexpandable precursors in the tunnel corresponds to the cooking time.

It is also possible to avoid the step of combining the protein concentrate and the water by directly using a liquid protein concentrate. Such a liquid concentrate is obtained before the final drying step during the production of protein concentrates in powder form. Generally, when the protein concentration of the liquid concentrate is greater than 30%, the temperature of the liquid protein concentrate must be maintained at more than 40° C. such that it does not harden. It can be considered that it is directly used, in the place of production thereof, for the production of dry expanded products of the invention.

In the case where the ingredients have been combined at a temperature greater than the ambient temperature, the mixture obtained is left to cool, to obtain the thermoexpandable precursor in the form of a gel or a paste. It can possibly be placed at a low temperature, for example in a refrigerator or a cold chamber of which the temperature is adjusted between 0° C. and 10° C.

If the dry expanded food product contains other ingredients, structural or not, they can be combined with the protein concentrate at the same time as water, or according to any other sequence making it possible to form a homogenous mixture.

The thermoexpandable precursor preferably contains between 15% and 50% by weight of protein, preferably between 20% and 40% by weight of proteins.

Preferably, the residual water content, i.e. the final content of the dry expanded product, is at least 3% by weight and at most 10% by weight of residual water.

The action of combining ingredients can comprise mixing, beating, emulsifying or any other action making it possible to obtain a preferably homogenous thermoexpandable precursor mixture.

The thermoexpandable precursor obtained, in the form of a paste or a gel, is possibly detailed in pieces, according to the form and the size of the expanded food product desired.

The food-grade dry expanded product of the third invention can also comprise cheese as another structural ingredient. The cheese containing, among others, proteins and fat, it directly contributes to the structural definition of the product.

The dry expanded food product can also only comprise, as structural ingredients, of the group constituted of a food-grade protein concentrate of animal or plant origin, cheese and residual water.

By cheese, any product likely to have the name of cheese must be considered here, i.e. a food substance resulting from the fermentation of milk curdled under the action of the rennet on the milk, or by acidifying it. In Europe, only products from animal milk are likely to be called cheese. Cheeses are classified in different categories, according to, for example, them being refined or not, according to the type of the rind thereof, or if they are produced from raw milk or pasteurised milk. The cheese used here can be added in powder form or in the full form thereof, i.e. non-dehydrated and non-crushed. For example, these could be pieces, of grated cheese, cheese scraps, refined or not or melted cheese, i.e. cheese re-melted with melting salts then repackaged. The dry expanded product of the invention thus makes it possible to use cheese parts usually not valued by the cheese industry.

Dry expanded products containing cheese also have the advantage of being particularly protein- and calcium-rich. A deficiency of these two elements being frequently observed during the ageing of individuals, the dry expanded product of the invention is therefore particularly suitable for an ageing population.

These products contain no gluten, they can also be consumed by people suffering from coeliac disease or people who are gluten-intolerant.

This aspect of the invention also relates to a method for producing a dry expanded food product constituted of or comprising, as structural ingredients, a food-grade protein concentrate or animal or plant origin, cheese and residual water, production method wherein
a thermoexpandable precursor is prepared, constituted of or comprising the following ingredients:
a food-grade protein concentrate of animal or plant origin,
cheese and
water,

preparation method comprising steps consisting of:
combining, at a temperature making it possible for the cheese to melt, cheese and water until forming a homogenous mixture;
combining with the preceding mixture, at a temperature of between 4° C. and 60° C., the protein concentrate of animal or plant origin, and

the thermoexpandable precursor is subjected to heat, in a microwave-type device, to cause the expansion thereof and the reduction of water content up to a residual content.

The temperature making it possible for cheese to melt can, of course, vary according to cheeses, but is generally of between 50° C. and 100° C.

Advantageously, initially, the cheese and the water are combined at a temperature making it possible for cheese to melt, preferably at a temperature of between 50° C. and 100° C., until the obtaining of a homogenous mixture, then secondly, the protein concentrate is added. The combination of the protein concentrate with the mixture can be done at the same temperature as for the combination of the cheese and of the water. Alternatively, the combination of the protein concentrate with the mixture can be done during the cooling of the water-cheese mixture, for example in a conventional baking kneader, i.e. non-temperature-controlled.

It can also be considered to combine cheese, water and protein concentrate in one single step to form a thermoexpandable precursor, in particular when the cheese is introduced in powder form.

In the methods described above, it can be considered to proceed, prior to the thermal microwave treatment, with a step of sterilising the thermoexpandable precursor, i.e. heating between 100° C. and 145° C., so as to reduce the presence of bacteria, viruses, yeasts or moulds.

The thermoexpandable precursor constituted of or comprising, as essential ingredients, a protein concentrate, water and cheese, has the advantage of forming a malleable, elastic and non-sticky paste, of the same type as pastes used in the biscuit industry. It is therefore possible to produce these dry expanded products on a large scale with a conventional biscuit industry device. It is no longer necessary to have moulds adapted to taking a gel, which makes it possible to achieve production savings. In certain cases, the food-grade fat, like for example an oil, can be added.

In certain cases, the dry expanded product can only comprise, as an essential ingredient, ingredients from the group constituted of a food-grade protein concentrate of animal or plant origin, food-grade fat, cheese and water.

Dry expanded products can, in addition to the structural ingredients, comprise auxiliary ingredients or additives, i.e. non-essential, not contributing to the structural definition of the product. These auxiliary additives mainly have an aromatic, nutritional and/or aesthetic function.

Aromatic auxiliary additives are, for example, flavours, synthetic or natural, salt, taste enhancers, spices, herbs or cooking seasoning.

Aesthetic additives are, for example, colourants or toppings.

Nutritional auxiliary additives are, for example, food fibres, soluble or non-soluble, such as defined above, minerals like calcium or potassium, vitamins, or any substance which could form the subject of a food supplement beneficial for human health in the scope of a preventative or curative treatment or a specific diet. The dry expanded product can, for example, contain up to 50% of food fibres without altering the crispiness and the crunchiness of the dry expanded product.

Generally, dry expanded products of the invention comprise from 35% to 97% by weight of protein, whatever the origin of the protein, i.e. whether it comes from the protein concentrate or cheese.

It can also be considered to add texturising additives of rennet type or a protein such as chymosin during the protein reconstitution, i.e. the mixture of the protein concentrate and water, in order to induce a coagulation of the mixture to obtain a cheese-type texture.

A lactic ferment or other living organism capable of acidifying the environment can also be used, as cited above, to produce, for example, dry expanded products of yogurt type to be made crispy.

Above, the possibility of subjecting the thermoexpandable precursor to heat by microwave has been mentioned. It is useful to note that if, furthermore, this calorific treatment was done under vacuum, a lower temperature can be proceeded with, which makes it possible to preserve the constituents of the composition, particularly when these are living lactic ferments (Techniques de l'Ingénieur, F3070, Chauffage micro-ondes comme éco-procédé en industrie agroalimentaire—Engineering Techniques, F3070, Microwave heating as an eco-method in the agribusiness industry—10 Mar. 2015). In the case of an atmospherically pressurised treatment, it is preferably to encapsulate the lactic ferments before the microwave treatment, or otherwise, to add them after cooking, for example, by crushing.

### EXAMPLE 1

In a mixer-cooker-emulsifier, with a dual case, for heating and cooling, connected to a heating double boiler and another cooler, and of volume 5 litres commercialised by the Stephan department of the company Sympak Process Engineering GmbH (Schwarzenbek, Germany), 1080 g of water and 600 g of milk protein isolate (86% protein content by weight with respect to the dry material) commercialised by the company Ingrédia (Arras, France) under the reference Promilk SH20 are introduced. This mixture is homogenised and emulsified (emulsion of oily globules suspended in water, and colloidal casein suspension in the aqueous phase) at the temperature of 80° C. for a duration of 20 minutes. The mixture is poured into a rectangular mould of a volume of 2.6 litres. The mixture distributed into circular silicone moulds of 4 cm in diameter, at 4 g per mould, then cooked for 55 seconds in a microwave oven with a power of 1000 W. The product obtained is an expanded snack (around 200%), crisp and crunchy.

### EXAMPLE 2

Example 1 is revisited by replacing the milk protein isolate with a Dena 90C soya protein isolate commercialised by Solina (Bréal-sous-Monfort, France). The recipe thus contains 1600 g of water for 500 g of soya protein isolate. After thermal treatment, the base is already gelled in the mixer-cooker. The gel, after transfer, is then split into discs of 25 mm in diameter and 4 mm in height. These discs are introduced by 8 in a microwave oven with a power of 1000 W and cooked for 60 seconds.

### EXAMPLE 3

In a bowl of a Thermomix of the brand Vorwerk of a volume of 1.5 L, are mixed 70 g of olive oil (Carrefour, Belgium) with 340 ml of source water by heating to 80° C. and while gently stirring (Thermomix in position 1) for 5 minutes. A powder-type mixture, containing 180 g of Promilk SH20 proteins (Ingrédia, Arras, France) and 90 g of camembert powder (Lactosan reference 160001) is then added while gently stirring (position 3 of the Thermomix). The mixture is maintained at 80° C. for 12 minutes. The paste thus formed is then placed on a worksurface and lowered to 8 mm in height with a rolling pin, then split into cylindrical discs of 18 mm in diameter. The discs are heated in a microwave oven with a power of 1800 W for 65 seconds. The volume obtained after passage to the microwave oven is, on average, 280% with respect to the initial volume [(volume after cooking)/(volume before cooking)*100%]. The product obtained is crisp and crunchy and has a relatively neutral taste.

### EXAMPLE 4

In a bowl of a Thermomix of the brand Vorwerk of a volume of 1.5 L, are mixed 35 g of olive oil (Carrefour, Belgium) with 340 ml of source water by heating to 80° C. and while gently stirring (Thermomix in position 1) for 5 minutes.

A powder-type mixture, containing 180 g of Promilk SH20 proteins (Ingrédia, Arras, France), 90 g of camembert powder (Lactosan reference 160001) and 35 g of Fibruline XL powder (Cosucra, Belgium) is then added while stirring at a medium speed (position 3 of the Thermomix). The mixture is maintained at 80° C. for 12 minutes. The mixture which has become a paste is then placed directly on a worksurface and lowered to 8 mm in height with a rolling pin, then split into cylindrical discs of 18 mm in diameter. The discs are heated in a microwave oven with a power of 1800 W for 65 seconds. The volume obtained after passage to the microwave oven is, on average, 225% with respect to the initial volume [(volume after cooking)/(volume before cooking)*100%]. The product obtained is crisp and crunchy and has a relatively neutral taste.

### EXAMPLE 5

It is possible to increase the proportion of Fibruline XL to 20% on dry material by modifying the formulation of example 4 as follows: 50 g of olive oil instead of 35 g, 377 ml of water instead of 340 ml, 82 g of Fibruline instead of 35 g. The dry expanded crunchy product is obtained with an expansion of 196%.

### EXAMPLE 6

It is possible to increase the proportion of Fibruline XL to 30% on dry material by modifying the formulation of example 4 as follows: 50 g of olive oil instead of 35 g and 136 g of Fibruline instead of 35 g. The mixture gives a more pourable paste. Silicone moulds of around 40mm in diameter and 18 mm in height are filled with 10 g of paste and placed in the microwave oven for 80 seconds. The volume obtained after cooking is, on average, 175% with respect to the initial volume.

### EXAMPLE 7

In a bowl of a Thermomix of the brand Vorwerk of a volume of 1.5 L, are mixed 260 g of Comté Entremont cheese and 280 ml of source water, by heating to 80° C. and while gently stirring (Thermomix in position 1) for 3 minutes.

The liquid obtained is poured into a kneader (Kenwood) and 140 g of Promilk SH20 proteins (Ingrédia, Arras, France) is added while gently stirring (position 2 of the Kenwood). The mixture is then kneaded for 12 minutes while stirring at a medium speed (position 3 of the Kenwood). The paste obtained is then place on a worksurface and lowered down to 8 mm in height with a rolling pin. The product split into cylindrical discs of 18 mm in diameter. The discs are heated in a microwave oven with a power of 1800 W for 65 seconds. The volume obtained after passage to the microwave oven is, on average, 260% with respect to the initial volume [(volume after cooking)/(volume before cooking)*100%]. The product obtained is crisp and crunchy and has quite a typical cheese taste.

### EXAMPLE 8

In a bowl of a Thermomix of the brand Vorwerk of a volume of 1.5 L, are mixed 70 g of olive oil (Carrefour, Belgium) and 340 ml of source water, by heating to 80° C. and while gently stirring (Thermomix in position 1) for 5 minutes.

The powder-type mixture, containing 180 g of milk and pea hybrid proteins (Ingredia Lab4884) and 90 g of camembert powder (Lactosan reference 160001) is added while gently stirring (position 3 of the Thermomix). The mixture stirred at 80° C. for 12 minutes. The paste obtained is then placed on a worksurface and lowered down to 8 mm in height with a rolling pin, then split into cylindrical discs of 18 mm in diameter. The discs are heated in a microwave oven with a power of 1800 W for 65 seconds. The volume obtained after passage to the microwave oven is, on average, 250% with respect to the initial volume [(volume after cooking)/(volume before cooking)*100%]. The product obtained is crisp and crunchy and has a relatively neutral taste.

### EXAMPLE 9

In a bowl of a Thermomix of the brand Vorwerk of a volume of 1.5 L, are mixed 70 g of olive oil (Carrefour, Belgium) and 340 ml of source water, by heating to 80° C. and while gently stirring (Thermomix in position 1) for 5 minutes.

The powder-type mixture, containing 180 g of soya proteins (reference Pro-Fam 974 of the company ADM Food & Wellness) and 90 g of camembert powder (reference 160001 of the company Lactosan, Denmark) is added while stirring at a medium speed (position 3 of the Thermomix). The mixture is maintained at 80° C. for 12 minutes. The paste obtained is then placed on a worksurface and lowered down to 2 mm in height with a rolling pin, then split into squares with sides of 30 mm. The squares are heated in a microwave oven with a power of 1800 W for 65 seconds. The volume obtained after passage to the microwave oven is, on average, 130% with respect to the initial volume [(volume after cooking)/(volume before cooking)*100%]. The product obtained is crisp and crunchy.

Table summarising recipe of examples 3 to 9 above:

| | | | | | | | |
|---|---|---|---|---|---|---|---|
| Ex. 3 | Ex. 4 | Ex. 5 | Ex. 6 | Ex. 7 | Ex. 8 | Ex. 9 | Ex. 10 |

Ingredients (g)

| | | | | | | | | |
|---|---|---|---|---|---|---|---|---|
| Water | 340 | 340 | 377 | 340 | 280 | 340 | 340 | 41 |
| Olive oil | 70 | 35 | 50 | 50 | | 70 | 70 | |
| SH20 | 180 | 180 | 180 | 180 | 140 | | | 89 |
| Hybrids | | | | | | 180 | | |
| Dena Soya | | | | | | | 180 | |
| Camembert (Lactosan) | 90 | 90 | 90 | 90 | | 90 | 90 | |
| Comte | | | | | 260 | | | |
| Melted | | | | | | | | 275 |
| Cheese (Cow) | | | | | | | | |
| Fibruline | | 35 | 82 | 136 | | | | |
| Alginate | | | | | | | | |

Techniques

| | | | | | | | | |
|---|---|---|---|---|---|---|---|---|
| Thermomix | X | X | X | X | X | X | X | X |
| Kneader | X | | | | X | | | |
| Drying | | | | | | | | |
| Gel | | | | X | | | | |
| Paste | X | X | X | | X | X | X | X |
| Roll | X | X | X | | X | X | X | X |

Expansion (%)

| | | | | | | | | |
|---|---|---|---|---|---|---|---|---|
| Expansion | 280% | 225% | 196% | 170% | 260% | 250% | 130% | 256% |

Composition of the dry expanded final product (% by mass)

| | | | | | | | | |
|---|---|---|---|---|---|---|---|---|
| Water | 5.00 | 5.00 | 5.00 | 5.00 | 5.00 | 5.00 | 5.00 | 5.00 |
| Proteins | 55.20 | 55.20 | 46.30 | 40.60 | 58.80 | | | 51.50 |
| Fat | 32.20 | 22.00 | 22.10 | 19.40 | 29.50 | | | 25.70 |
| Carbohydrates | 1.30 | 11.60 | 21.30 | 30.30 | 0.90 | | | 9.60 |
| Ash | 6.30 | 6.20 | 5.30 | 4.70 | 5.80 | | | 8.20 |

Table of recipes where the thermoexpandable precursor is obtained in gel form:

| Recipe | | | | | | |
|---|---|---|---|---|---|---|
| 1 | 2 | 3 | 4 | 5 | 6 | 7 |

Base element recipe (%)

| | | | | | | | |
|---|---|---|---|---|---|---|---|
| Everyday source water | 67.8 | 66.3 | 59.1 | 54.82 | 66.13 | 67.2 | 64.29 |
| Ingredia Promilk SH20 | 20.67 | 23.1 | 26.1 | 24.35 | 23.15 | 20.2 | 35.71 |
| Corman Standard AMF | 9.2 | 10.4 | 6.9 | 8.7 | 8.9 | 5 | X |

Others (%)

| | | | | | | | |
|---|---|---|---|---|---|---|---|
| Lactosan camembert | X | X | 6.9 | 12.15 | X | X | X |
| powder | | | | | | | |
| Meurens Pioca 10 | 1.3 | X | X | X | X | 6.3 | X |
| maltodextrin | | | | | | | |
| Nestlé milk powder | X | 0.1 | X | X | X | X | X |
| k-carrageenan | 0.16 | X | X | X | X | 0.16 | X |
| Carob bean gum | 0.07 | X | X | X | X | 0.07 | X |
| Calcium chloride | X | X | X | X | 0.8 | X | X |
| Glucono-delta-lactone | 1 | X | 1 | X | 1 | 1 | X |

Auxiliaries (%)

| | | | | | | | |
|---|---|---|---|---|---|---|---|
| Rennet (CHY-MAX+) | YES | YES | YES | X | YES | YES | X |
| Hansen YFL 812 | X | 0.15 g/L | X | X | X | X | X |
| ferments | | | | | | | |

Total

| | | | | | | |
|---|---|---|---|---|---|---|
| 100 | 100 | 100 | 100 | 100 | 100 | 100 |

Composition of the finished product (%)

| | | | | | | | |
|---|---|---|---|---|---|---|---|
| Proteins | 50.6 | 51.9 | 54.1 | 52.9 | 54.7 | 49 | 81.4 |
| Lipids | 28.6 | 28.3 | 22.4 | 31.4 | 26.6 | 15.9 | 2 |
| Carbohydrates | 6.8 | 7 | 3.1 | 3.4 | 2.7 | 21.5 | 3.9 |
| Water | 5 | 5 | 5 | 5 | 5 | 5 | 5 |

Mineral composition (mg/100 g)

| | | | | | | | |
|---|---|---|---|---|---|---|---|
| Calcium | 1431 | 1465 | 1.373 | 1226 | 2016 | 1385 | 2282 |
| Phosphorus | 798 | 816 | 770 | 688 | 862 | 772 | 1282 |
| Sodium | | | | | | | |

pH

| | | | | | | | |
|---|---|---|---|---|---|---|---|
| Base | 5.6 | 5.65 | 5.7 | 6.33 | 5.5 | 5.6 | 6.3 |
| Finished product | NA | NA | NA | NA | NA | NA | NA |

Table of technologies used in the recipes of the preceding table:

| Recipe | | | | | |
|---|---|---|---|---|---|
| 1 | 2 | 3 | 4/7 | 5 | 6 |

Stephan Process

| | | | | | | |
|---|---|---|---|---|---|---|
| Max | 70 | 70 | 80 | 80 | 70 | 70 |
| temperature (° C.) | | | | | | |
| Rehydration | 20 | 20 | 20 | 20 | 20 | 20 |
| time (mins) | | | | | | |
| Stirring (rpm) | 1000 | 1000 | 600 | 600 | 1000 | 1000 |
| Relative | −0.6 | −0.6 | 0 | 0 | −0.6 | −0.6 |
| vacuum (bars) | | | | | | |
| Min | 45 | 45 | 45 | 80 | 45 | 45 |
| temperature (° C.) | | | | | | |

Particularity

| | |
|---|---|
| Rebalancing of | 10 |
| minerals | to 45° C. |

Addition of auxiliaries

| | | | | | | |
|---|---|---|---|---|---|---|
| Rennet | YES | X | YES | X | YES | YES |
| Ferments | X | 0.15 g/L | X | X | X | X |

Addition of additives

| | | | | | | |
|---|---|---|---|---|---|---|
| GDL (%) | YES | YES | YES | X | YES | YES |

Moulding

| | | | | | | |
|---|---|---|---|---|---|---|
| Temperature (° C.) | 20 | 42 | 20 | 20 | 20 | 20 |
| Dimensions (L)¹ | 2.6 | 2.6 | 2.6 | 2.6 | 2.6 | 2.6 |

Demoulding

| | | | | | | |
|---|---|---|---|---|---|---|
| Time (hours) | 2 | 4 | 2 | 0 | 2 | 2 |
| Temperature (° C.) | 20 | 42 | 20 | 20² | 20 | 20 |

Forming

| | | | | | | |
|---|---|---|---|---|---|---|
| Dimensions (mm) | 14 × 14 × 14³ | 14 × 14 × 14 | 25 × 5⁴ | 25 × 5⁴ | 14 × 14 × 14 | 25 × 5⁴ |

Drying

| | | | |
|---|---|---|---|
| Temperature (° C.) | 30 | 30 | 30 |
| Hygrometry (% HR) | 45 | 45 | 45 |
| Time (hours) | 20 | 20 | 20 |

Rebalancing

| | | | |
|---|---|---|---|
| Temperature (° C.) | 15 | 15 | 15 |
| Hygrometry (% HR) | 85 | 85 | 85 |
| Time (hours) | 48 | 48 | 48 |

Cooking

| | | | | | | |
|---|---|---|---|---|---|---|
| Power (Watts) | 1000 | 1000 | 1000 | 1000 | 1000 | 1000 |
| Time (secs) | 35 | 35 | 50 | 45 | 35 | 70 |
| Initial humidity (%) | 18 | 18 | 55 | 55 | 18 | 65 |
| Final humidity (%) | 5 | 5 | 5 | 5 | 5 | 5 |

¹2.6 L Tupperware Curver
²Can be cooked directly exiting Stephan or after gelling in the refrigerator
³Cube
⁴Disc

1. Dry expanded food product only comprising, as structural ingredients, ingredients of the group constituted of a food-grade protein concentrate of animal or plant origin, and residual water.

2. Dry expanded food product comprising at least the following essential ingredients:
a food-grade protein concentrate of animal or plant origin, and
residual water.

3. Food product according to claim 2 also comprising cheese.

4. Food product according to claim 3, which comprises at least one cheese from the group comprising refined cheese, non-refined cheese, melted cheese and powdered cheese.

5. Food product according to claim 1, comprising 35% to 97% by weight of protein.

6. Food product according to claim 1, comprising at least one aromatic, nutritional and/or aesthetic auxiliary additive.

7. Food product according to claim 6, comprising as a nutritional auxiliary additive, food fibres.

8. Dry expanded food product according to claim 1, wherein the food-grade animal protein concentrate is a milk protein concentrate.

9. Food product according to claim 2, only comprising as structural ingredients, ingredients from the group constituted of a food-grade protein concentrate of animal or plant origin, cheese, and residual water.

10. Food product according to claim 2, also comprising as a structural ingredient, added food-grade fat.

11. Food product according to claim 2, only comprising as structural ingredients, ingredients from the group constituted of a food-grade protein concentrate of animal or plant origin, cheese, a food-grade fat and residual water.

12. Food product according to claim 2, also comprising as a structural ingredient, a food-grade texturising additive selected from among the group constituted of hydrocolloids and plant gelling agents, preferably modified starch, proteolytic additives and the hydrolysed products thereof, non-starch polysaccharides, acidifying agents and the salts thereof, and maltodextrins.

13. Food product according to claim 1, also comprising living lactic ferments or living biological acidifying agents.

14. Thermoexpandable precursor capable of forming a dry expanded food product according to claim 1.

15. Thermoexpandable precursor capable of forming a dry expanded food product according to claim 2.

16. Thermoexpandable precursor capable of forming a dry expanded food product according to claim 3.

17. Thermoexpandable precursor according to claim 14, comprising aromatic and/or nutritional auxiliary additives.

18. Thermoexpandable precursor according to claim 14, in the form of a gel.

19. Thermoexpandable precursor according to claim 14, in the form of a paste.

20. Method for producing a dry expanded food product comprising a food-grade protein concentrate of animal or plant origin, and residual water, production method wherein
a thermoexpandable precursor constituted of the following ingredients is prepared:
a food-grade protein concentrate of animal or plant origin, and
water,
method for preparing the precursor comprising the step consisting of:
combining, at a temperature of between 4° C. and 100° C., the protein concentrate of animal or plant origin and water, and
the thermoexpandable precursor is subjected to heat, in a microwave-type device, to cause the expansion thereof and the reduction of water content down to a residual content.

21. Method for producing a dry expanded food product according to claim 1, comprising a food-grade protein concentrate of animal or plant origin, and residual water, production method wherein a food-grade liquid protein concentrate of animal or plant origin is subjected to heat, in a microwave-type device, to cause the expansion thereof and the reduction of water content down to a residual content.

22. Method for producing a dry expanded food product according to claim 2, comprising a food-grade protein concentrate of animal or plant origin, cheese and residual water, production method wherein
a thermoexpandable precursor comprising the following ingredients is prepared:
a food-grade protein concentrate of animal or plant origin,
cheese, and
water,
preparation method comprising the steps consisting of:
combining, at a temperature making it possible for the cheese to melt, cheese and water until forming a homogenous mixture;
combining with the preceding mixture, at a temperature of between 4° C. and 100° C., the protein concentrate of animal or plant origin, and
the thermoexpandable precursor is subjected to heat, in a microwave-type device, to cause the expansion thereof and the reduction of water content down to a residual content.

23. Production method according to claim 20, according to which the thermoexpandable precursor is subjected to heat and under vacuum.

24. Production method according to claim 20, wherein the microwave oven is a microwave tunnel.
